(19) United States
(12) Patent Application Publication
(10) Pub. No.: US 2006/0037985 A1
(43) Pub. Date: Feb. 23, 2006

(54) Compact disc storage device for a vehicle visor

(76) Inventors: David L. Hiemstra, Hudsonville, MI (US); Gregory C. Stapert, Caledonia, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/921,585

(22) Filed: Aug. 19, 2004

(51) Int. Cl. B60J 3/00; B60R 7/05

(52) U.S. Cl. 224/312; 296/97.5

(57) ABSTRACT

A compact disc storage holder is formed by a warning label that is attached to a vehicle visor. A plurality of pockets is created for holding compact discs on the vehicle visor.

### BACKGROUND OF THE INVENTION

The present invention pertains to a vehicle visor compact disc holder, and particularly to one that is incorporated into a warning label on the vehicle visor.

With increasing use of compact disc players in vehicles, there is a significant need for the convenient storage of compact discs. It is convenient for the occupant, and, in particular, a driver of a vehicle, to store compact discs in an easily accessible location. It is also important that the storage location be in a position that allows the driver to keep the driver's eyes substantially on the road while retrieving or returning a compact disc to the storage location. Additionally, with limited space in an automobile, it is desirable that the storage device be small enough to be non-obstructive.

Ideally, the storage device also holds a number of compact discs in a manner that will not scratch the surface of the compact disc. Since compact discs are ordinarily stored in plastic containers, which typically require two hands to open, it is desirable to provide the storage of compact discs in an accessible location in the vehicle without the plastic container. Thus, a driver will only need to use one hand to access the compact disc while keeping the other hand on the steering wheel.

There exists a need, therefore, for a compact disc storage device that easily accessible by an occupant of a vehicle and safely stores compact discs. There also exists a need for a storage device that allows one hand to access compact discs outside their plastic containers. Further, with increasing sensitivity to costs of vehicle components by manufacturers, it is desirable to have a compact disc storage device that is relatively inexpensive and requires less materials.

### SUMMARY OF THE INVENTION

The compact disc storage device of the present invention solves the need for a relatively inexpensive compact disc storage device that is easily accessible by an occupant, and, in particular, a driver of a vehicle. It accomplishes this goal by providing a compact disc holder that is integrated into the warning label of a vehicle visor. Pockets are formed between the warning label and the vehicle visor.

Vehicle visors embodying the present invention include storage locations for compact discs such that a driver can access the compact disc by reaching up with one hand to the vehicle visor.

These and other features, advantages and objects of the present invention will be further understood and appreciated by those skilled in the art by reference to the following specification, claims, and appended drawings.

### BRIEF DESCRIPTION OF THE DRAWINGS

FIG. 1 is a front perspective view of the invention showing a holder for two compact discs; and

FIG. 2 is a front perspective view of the invention showing a holder for a plurality of compact discs.

### DETAILED DESCRIPTION OF THE PREFERRED EMBODIMENT

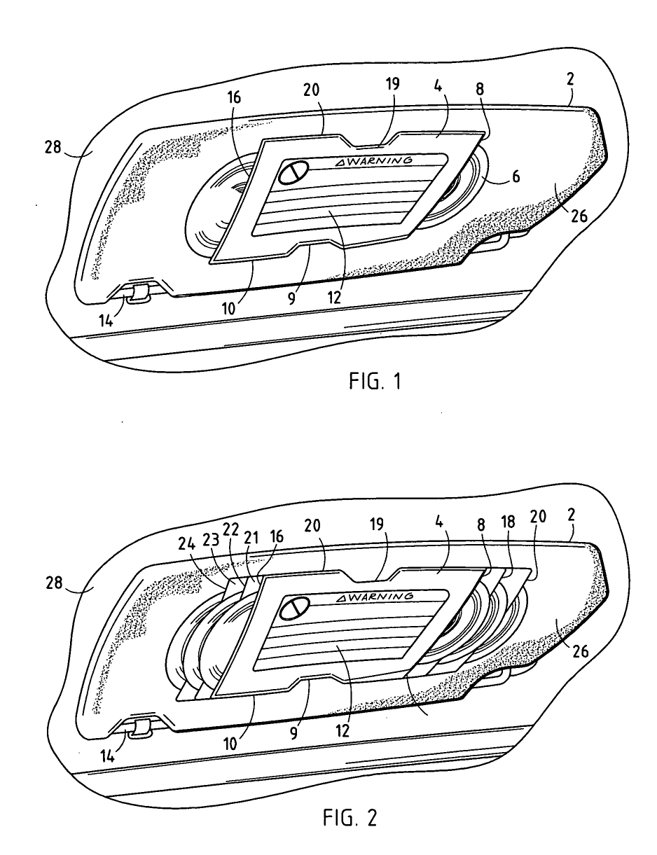

Referring initially to FIG. 1, there is shown a vehicle visor 2 embodying the present invention. The vehicle visor 2 includes a visor body 26, which is attached to a visor elbow 14, which attaches the visor 2 to the vehicle. Typically, the visor 2 is rotatably mounted to the roof 28 of a vehicle. FIG. 1 illustrates the visor 2 in a retracted position close to the roof lining and not in the operative position along either the front windshield or along the side window. A warning label 4 including printed warning material 12 is attached to the visor body 26 of the visor 2. As described in more detail below, the warning label 4 is attached to the visor body 26 of the visor 2 around the periphery of the warning label 4 along edges 10 and 20. Edge 10 preferably includes a portion 9 that is indented, and edge 20 preferably includes a portion 19 that is indented. The indented portions 9 and 19 thereby limit the depth to which the compact discs can be inserted into pockets 8 and 16, thereby ensuring that a portion of the compact discs 6 extend out of the pockets 8 and 16 so they can be readily grasped by a user. However, edges 10 and 18 of the warning label 4, which are generally perpendicular to the visor elbow 14, are not completely attached to the visor body 26 of the visor 2. Thus, a pocket is formed between the warning label 4 and the visor body 26 of the visor 2. As illustrated in FIG. 1, the warning label 4 is a sufficient size in order to create a first pocket 8 and a second pocket 16, on the right and left sides of the warning label 4. Label 4 thereby not only provides the necessary warning information, but also forms pockets for holding compact disks and the like. In this way, the label 4 provides additional functional features without requiring additional material for fabrication.

In another embodiment (FIG. 2), the warning label 4 is attached to visor body 26 of the visor 2 in a similar manner. However, this embodiment includes a plurality of pockets on both the left and right sides of the warning label 4. As illustrated, three pockets 16, 22, and 24 are shown on the left side of the warning label 4, while three pockets 8, 18, and 20 are shown on the right side of the warning label 4. Layers of material 21 and 23 are secured to each other along the edges 10 and 20, and layer 23 is secured to visor body 26 along the edges 10 and 20. Also, layer 21 is secured to label 4 along edges 10 and 20. Pockets 16 and 8 are formed between label 4 and layer 21, and pockets 18 and 22 are formed between layers 21 and 23, and pockets 20 and 24 are formed between layer 23 and visor body 26. The layers 21 and 23 are may be made of the same material as warning label 4, or other suitable material.

The warning label 4 may be made of any suitable material, including, but not limited to, polymeric materials, such as vinyl. Additionally, the warning label 4 is attached to the visor body 26 of the visor 2 by a suitable fastening means, such as stitching, adhesive, etc. The visor body 26 may have an outer covering of vinyl cloth, or other material. The label 4 may be secured to the visor body 26 by a known heat sealing process, wherein the edges 10 and 20 are pressed into contact with the visor body 26 utilizing a heated tool. The edges 10 and 20 of label 4 are thereby melted. If the visor body 26 is made of a fabric material, the edges 10 and 20 melt into the fabric, thereby securely connecting the label 4 to the visor body 26. If the outer layer of the visor body 26 is a vinyl or other polymeric material, the label 4 and visor body 26 melt together, to thereby secure the label 4 to the visor body 26. As noted above, conventional adhesives or the like may also be utilized to connect the edges 10 and 20 of label 4 to visor body 26. Also, in the embodiment of FIG. 2, the layers 21 and 23 may be made of a polymer material, such that the layers 21 and 23 are melted together along edges 10 and 20, and also melt to the label 4 and visor body 26 utilizing substantially the same heat sealing process.

The compact disc storage of the present invention provides a very simple and cost-effective, yet useful arrangement for storing CDs and the like on a visor. Because warning labels 4 relating to airbags or other items may be required, the compact disc storage arrangement of the present invention provides additional functionality without substantially adding to the cost of the visor.

The above description is considered that of the preferred embodiment only. Modification of the invention will occur to those skilled in the art and to those who make or use the invention. Therefore, it is understood that the embodiment shown in the drawings and described above is merely for illustrative purposes and not intended to limit the scope of the invention, which is defined by the following claims as interpreted according to the principles of patent law, including the doctrine of equivalents.

The invention claimed is:

1. A sun visor assembly for a motor vehicle adapted to store a plurality of compact discs, the sun visor assembly comprising:
a visor body having an outer cover at least a portion of which comprises a fabric material; and
a warning label made of a sheet of polymer material and having printed matter thereon, wherein the warning label has a first edge portion attached to said visor body and includes a second edge portion that is not attached to the visor body to define any number of pockets for receiving compact discs.

2. The sun visor assembly of claim 1, wherein:
the outer cover of the visor body comprises a cloth material.

3. The sun visor assembly of claim 2, wherein:
some of the material of the warning label is melted into the cloth.

4. The sun visor assembly of claim 3, wherein:
the first edge portion comprises opposite front and rear edge portions, and the second edge portion comprises side edges to define opposite side pockets.

5. The sun visor assembly of claim 4, wherein:
the front and rear edge portions have indented centers that limit the depth of the side pockets.

6. The sun visor assembly of claim 1, wherein:
the outer cover of the visor body comprises a polymeric material.

7. The sun visor assembly of claim 6, wherein:
the first edge portion of the warning label is melted to the outer cover of the visor body.

8. The sun visor assembly of claim 1, including:
at least one intermediate sheet of material disposed between the warning label and the outer cover of the visor body to define pockets on opposite sides of the intermediate sheet for holding compact discs.

9. The sun visor assembly of claim 8, wherein:
the intermediate sheet of material is made of the same polymer material as the warning label.

10. A visor for a motor vehicle, comprising:
a generally flat, oblong visor body including mounting structure for movably securing the visor body to a vehicle, the visor body defining a side surface;
a label made of a thin sheet of material and having front and rear edges and opposite side edges defining a generally rectangular shape, the label including printed matter on an outer side surface; and wherein:
at least a portion of the front and rear edges of the label are secured to the side surface of the visor body, and at least a portion of the side edges are not secured to the side surface of the visor body to thereby define a pair of pockets for receiving compact discs.

11. The visor of claim 10, wherein:
the visor body includes an outer cover.

12. The visor of claim 11, wherein:
the outer cover of the visor body comprises a cloth material.

13. The visor of claim 12, wherein:
some of the material of the label is melted into the cloth.

14. The visor of claim 13, wherein:
the front and rear edges have indented centers that limit the depth of the pockets.

15. The visor of claim 11, wherein:
the outer cover of the visor body comprises a polymeric material.

16. The visor of claim 5, wherein:
the first edge of the label is melted to the outer cover of the visor body.

17. The visor of claim 11, including:
at least two intermediate sheets of material disposed between the warning label and the outer cover of the visor body to define a plurality of pockets for holding compact discs.

18. A method of making a visor for vehicles, comprising:
providing a visor body having an outer covering;
forming a pocket for holding compact discs by attaching a label having printed warning matter thereon to the outer covering of the visor body by melting first edge portions of the label to the outer covering, and by leaving second edge portions of the label unattached to the outer covering of the visor body to form the pocket for holding compact discs.

19. The method of claim 18, wherein:
the outer covering is a fabric material; and
some of the material of the label is melted into the fabric.

20. The method of claim 19, wherein:
the label and the outer covering are made of a polymer material.
